(19) United States
(12) Patent Application Publication
(10) Pub. No.: US 2003/0159246 A1
(43) Pub. Date: Aug. 28, 2003

(54) Electrically non-conductive handle for a multi-purpose folding hand tool

(76) Inventor: Christopher Gerard McCall, Spring, TX (US)

Correspondence Address: CHRISTOPHER G. McCALL, 742 MERRIMAC RIDGE, SPRING, TX, 77373, US

(21) Appl. No.: 10/373,035

(22) Filed: Feb. 24, 2003

Related U.S. Application Data
(60) Provisional application No. 60/360,511, filed on Feb. 28, 2002.

(51) Int. Cl. B25G 1/00

(52) U.S. Cl. 16/110.1

(57) ABSTRACT

The prior art of manufacture of multi-purpose folding hand tools utilizes metal as the material of composition for the handles of the hand tools. The use of an electrically non-conductive material as the sole component of material to fabricate the handles of the hand tool is new to the art.

### CROSS REFERENCE TO RELATED APPLICATIONS

Not Applicable.

### STATEMENT REGARDING FEDERALLY FUNDED SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention pertains to the plethora of multi-purpose folding hand tools that are readily available in the commercial market. These hand tools usually have several screwdrivers, wire cutters, pliers, knife blades and miscellaneous items that are attached to the hand tools' handles by a pivoting mechanism. When not in use, these tool implements are stored inside the “U” shaped handles of the hand tool.

The compact size and flexibility of the multi-purpose hand tools make them very useful in countless daily activities including home repairs, automotive repairs, construction work and outdoor activities.

The handles and tool implements of these multi-purpose folding hand tools are typically fabricated from any of a variety of metals. Metal is a good conductor of electricity.

The screwdriver and wire cutter implements of these hand tools lend themselves to be used in do-it-yourself type electrical projects. Using an uninsulated metal tool implement on or in close proximity to live electrical circuits is extremely hazardous, potentially even fatal.

### BRIEF SUMMARY OF THE INVENTION

The object of this invention is to provide an added benefit and safety to the user of a multi-purpose folding hand tool.

This invention is a new way to fabricate the handles of the multi-purpose folding hand tools that will offer some protection from electric shock to the user.

### BRIEF DESCRIPTION OF THE SEVERAL VIEWS OF THE

### DRAWING

Not Applicable.

### DETAILED DESCRIPTION OF THE INVENTION

Current manufacturing methods use metal as the material to fabricate the handles of the multi-purpose folding hand tool. The metal handles are attached to the metal tool implements with a metal pivot mechanism. Thus, when in use the entire hand tool is a conductor of electricity. If the hand tool comes in contact or close enough proximity to an electrical source, the user may experience an electrical shock.

This invention is an improvement to the handles of the multipurpose folding hand tools. This invention requires both handles of the multi-purpose folding hand tool to be manufactured solely and completely from an electrically non-conductive material. The material for the hand tool handles shall be manufactured from a synthetic or naturally occurring material rated to withstand a minimum of 600 volts AC.

The non-conductive handle material shall be strong enough to maintain the working pressures a multi-purpose folding hand tool is normally exposed to.

The non-conductive handle material will allow the manufacturer to fabricate the handles in a variety of colors.

What I claim as my invention is:

1. The handles of multi-purpose folding hand tools being manufactured solely and completely from an electrically nonconductive material, such material being composed and fabricated from either synthetic or naturally occurring raw material, rated to withstand a minimum of 600 volts AC, providing the hand tool user with some protection from electric shock.
